(19) United States
(12) Patent Application Publication
(10) Pub. No.: US 2018/0225378 A1
(43) Pub. Date: Aug. 9, 2018

(54) BOOSTING RANKING OF CONTENT WITHIN A TOPIC OF INTEREST

(71) Applicant: Flipboard, Inc., Palo Alto, CA (US)

(72) Inventors: Arnab Bhadury, Vancouver (CA); Vlad Ionut Cora, Burnaby (CA); Benjamin John Frederickson, Vancouver (CA)

(21) Appl. No.: 15/425,976

(22) Filed: Feb. 6, 2017

(51) Int. Cl. G06F 17/30; G06F 7/02

(52) U.S. Cl. CPC G06F 17/30867; G06F 7/026

(57) ABSTRACT

A digital magazine server generates a personalized digital magazine tailored for the interests of a user with subtopic specificity. The digital magazine server identifies topics of interest for a user and one or more subtopics related to each topic. For each subtopic, the digital magazine server infers whether the subtopic is of interest to the user based on prior user actions performed by the user or social signals describing the user's actions with content items, such as following content items from the user's influencers. For subtopics that are of interest, relevant content items are identified and boosted in comparison to other content items that are only relevant to the topic of interest. Thus, the digital magazine server generates a personalized content feed for the user with the boosted content items, thereby enabling more relevant presentation of content items that are likely to be of interest to the user.

### BACKGROUND

This invention generally relates to digital content, and more specifically to presenting a personalized content feed to a user of a digital magazine server by boosting ranking of content items on a topic based on the user's selection of subtopics and signals indicating the user's social behavior related to the content items in the content feed.

Digital distribution channels disseminate content items including text, images, audio, links, videos, and interactive media (e.g., games, collaborative content) to various users. Although users of online systems can access more content than before, the broad selection available can overwhelm users. Therefore, digital distribution channels seek to tailor the presentation of content items to increase the likelihood that a user is interested in the presented content items. However, various conventional techniques lack the necessary specificity when providing tailored content to users. Therefore, conventional techniques result in content that may be generally relevant to a user, but may be of low interest to the user. As such, presentation of this content provides for poor user experience and digital distribution channels often experience low user retention as a result.

### SUMMARY

A digital magazine server retrieves content from various sources and generates a personalized digital magazine for a user of the digital magazine server. The personalized digital magazine includes boosted content items on a topic due to their relevance to a subtopic that the user is likely interested in. The digital magazine server identifies a user interest in a topic, and further identifies user interest with further specificity in relation to one or more subtopics of the topic. Therefore, content items relevant to one or more subtopics that the user is interested in are boosted in relation to other content items. The digital magazine is personalized to include content items that are more relevant for a user of the digital magazine server.

More specifically, the digital magazine server first retrieves content items from sources and generates baseline feeds of content that are each specific for a particular topic. Content items in each baseline feed of content are relevant to the topic. The digital magazine server may further associate each content item with one or more subtopics of that topic. In various embodiments, content items on a subtopic may be provided by a provider of content items (e.g., a magazine or a publisher) that has previously provided content items that are related to the topic.

The digital magazine server identifies user interest in a topic for a user of the digital magazine server, and retrieves the baseline feed of content that corresponds to the topic of interest. Furthermore, for that topic of interest, the digital magazine server identifies whether the user is interested in particular subtopics. For example, a user can personally provide an indication that certain subtopics are of interest. As another example, the digital magazine server infers user interest in subtopics by accounting for prior user actions taken by the user on the digital magazine server. The digital magazine server may further identify the user's interest and personal preference for content items on a topic based on the user's social behaviors, e.g., the user's followings of other digital content resources on the same or similar topic and other users of the digital magazine server, who are known for preferences of content items on the topic.

Having identified the subtopics that a user is interested in and signals indicating the user's preference for content items, the digital magazine server boosts the content items in the baseline feed of content that are relevant to the identified subtopics and preference for content items. Content items that are deemed irrelevant or less relevant to the identified subtopics are not boosted. Therefore, the digital magazine server generates a personalized feed of content for presentation to the user that includes the boosted content items. For example, the boosted content items may be positioned within the personalized feed of content according to their extent of boosting. As such, a user of the digital magazine server can consume content items that are more relevant given that they are tailored according to user interests at a higher specificity (e.g., subtopics).

### BRIEF DESCRIPTION OF THE DRAWINGS

FIG. 1 is a block diagram of a system environment in which a digital magazine server operates, in accordance with an embodiment.

FIG. 2 is a block diagram of a digital magazine server, in accordance with an embodiment.

FIG. 3 is an example personalized feed of content in a digital magazine, in accordance with an embodiment.

FIG. 4A illustrates subtopics associated with a topic in a digital magazine server, in accordance with an embodiment.

FIG. 4B depicts the boosting of content items in a personalized content feed, in accordance with an embodiment.

FIG. 5 is a flowchart for generating a personalized feed of content for a user of the digital magazine server, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

Additionally, the figures use like reference numerals to identify like elements. A letter after a reference numeral, such as “405A,” indicates that the text refers specifically to the element having that particular reference numeral. A reference numeral in the text without a following letter, such as “405,” refers to any or all of the elements in the figures bearing that reference numeral (e.g. “subtopic 405” in the text refers to reference numerals “subtopic 405A” and/or “subtopic 405B” in the figures).

### DETAILED DESCRIPTION

### Overview

A digital magazine server generates a personalized feed of content that is tailored to the interests of a user, and presents the personalized feed of content to the user in a digital magazine. A “digital magazine” herein refers to an aggregation of digital content items that can be presented to users in a presentable format similar to the format used by print magazines. In one embodiment, a digital magazine assembles a list of universal resource locators (URLs), where each article of the digital magazine is based on the content of a resource on the Internet to which a URL of the list of the URLs references to. The digital magazine server identifies topics that a user is interested in and for each topic, further identifies subtopics that match the user's preference for digital content. As such, the digital magazine server boosts content items that are relevant to both the topic and subtopics of interest in comparison to other content items that are only relevant to the topic of interest. Thus, the digital magazine server generates a personalized feed of content including the boosted content items. The personalized feed of content is generated taking into consideration a user's interests at a subtopic level, thereby enabling more relevant presentation of content items that are likely to be of interest to the user.

### System Architecture

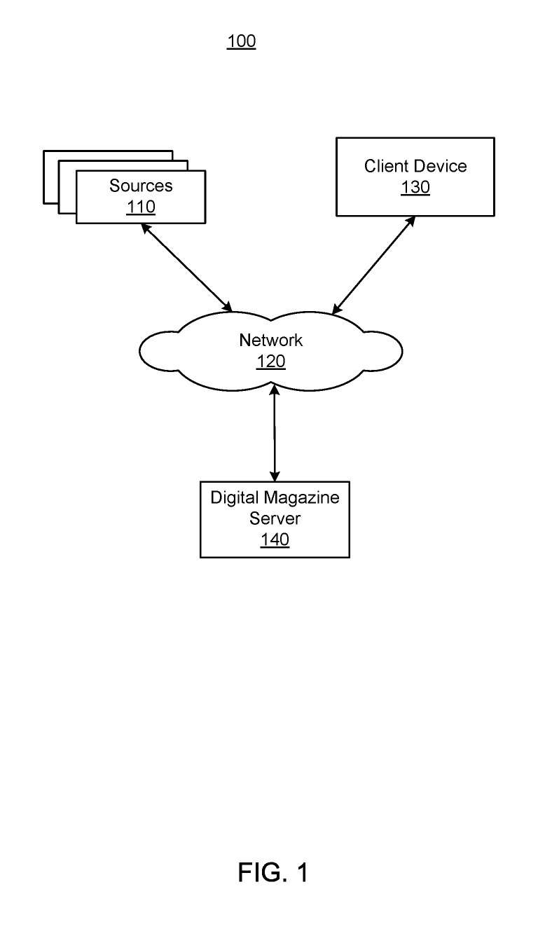

FIG. 1 is a block diagram of a system environment 100 for a digital magazine server 140. The system environment 100 shown by FIG. 1 comprises one or more sources 110, a network 120, a client device 130, and the digital magazine server 140. In alternative configurations, different and/or additional components may be included in the system environment 100. Additionally, the embodiments described herein can be adapted to online systems that are not digital magazine servers 140.

A source 110 is a computing system capable of providing various types of content to a client device 130 and the digital magazine server 140. Examples of content provided by a source 110 include text, images, video, or audio on web pages, web feeds, social networking information, messages, or other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as a “content item,” or as “content.” A content item may include various types of content elements such as text, images, video, interactive media, links, and a combination thereof.

The sources 110 communicate with the client device 130 and the digital magazine server 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.1, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The client device 130 is a computing device capable of receiving user input as well as transmitting and/or receiving data via the network 120. In one embodiment, the client device 130 is a conventional computer system, such as a desktop or a laptop computer. Alternatively, the client device 130 may be a device having computer functionality, such as a personal digital assistant (PDA), a mobile telephone, a smartphone or another suitable device. In one embodiment, the client device 130 executes an application enabling a user of the client device 130 to interact with the digital magazine server 140. For example, an application executing on the client device 130 communicates instructions or requests for a personalized feed of content items to the digital magazine server 140. In one embodiment, the client device 130 sends the instructions or requests upon initial execution (e.g., opening) of the application. As another example, the client device 130 executes a browser that receives pages from the digital magazine server 140 and presents the pages to a user of the client device 130. In another embodiment, the client device 130 interacts with the digital magazine server 140 through an application programming interface (API) running on a native operating system of the client device 130, such as IOS® or ANDROID™. While FIG. 1 shows a single client device 130, in various embodiments, any number of client devices 130 may communicate with the digital magazine server 140. Different client devices 130 may have different characteristics such as different processing capabilities, different connection speeds with the digital magazine server 140 over the network 120, and different device types (e.g., make, manufacture, and version).

In various embodiments, a client device 130 may be configured to present information to and receive information from a user of the client device 130. For example, the client device 130 may include a user interface such as a display that the client device 130 uses to present content (such as content items of the digital magazine server 140) to the user. Additionally, a user of the client device 130 can provide user inputs through a user interface. Inputs received via a user interface of the client device 130 may be processed by a digital magazine application associated with the digital magazine server 140 and executed on the client device 130 to allow a user of the client device 130 to interact with content items presented by the digital magazine server 140. As an example, a user input provided by a user of the client device 130 may indicate a user interest in a particular topic or subtopic. More specifically, a user of the client device 130 can provide, through the user interface, a selection of topics and/or subtopics that the user is interested in. The client device 130 can provide these user selections to the digital magazine server 140 for creation of the personalized feed of content.

The digital magazine server 140 receives content items from one or more sources 110 and generates personalized content feeds for users of the digital magazine server 140 by processing the received content. The digital magazine server 140 provides a personalized content feed to the client device 130 such that a user of the client device 130 (or user of the digital magazine server 140) can readily access content items in the personalized content feed that are likely to be of interest to the user.

More specifically, for a particular user, the digital magazine server 140 determines a topic of interest for the user and retrieves a baseline feed of content that includes content items received from sources 110, e.g., content items without being filtered based on the user's selection of subtopics or preference for content items, each content item in the baseline feed being related to the topic of interest. The digital magazine server 140 identifies subtopics of the topic of interest and amongst the subtopics, further identifies subtopics that the user is likely interested in. In various embodiments, a content item has a topic, and each topic may have one or more related subtopics. Multiple content items may share or relate to a topic or a subtopic. For example, a topic on sailing may have a subtopic on Caribbean sailing and another subtopic on different types of yachts for sailing. For another example, the topic of 2016 U.S. presidential election has a subtopic of Donald Trump running for the president and another subtopic of Hilary Clinton running for the president. In various embodiments, a subtopic is more specific than a topic and therefore, provides an additional level of granularity in understanding a user's interests in the topic.

The digital magazine server 140 can further identify content items to be boosted based on social signals indicating a user's preference for content items. Examples of such social signals include the user's followings of other digital content resources on the same or similar topic and other users of the digital magazine server, such as a contributing source 110 of newspaper, news outlet, magazine, and the like on the same or similar topic or an individual influencer (e.g., celebrity, expert in a field, and the like).

The digital magazine server 140 identifies content items in the baseline feed of content that are related to the subtopics that a user is likely interested in and boosts those content items in relation to other content items that are not related to subtopics that a user is likely interested in. Therefore, the digital magazine server 140 can generate a personalized feed of content including content items boosted according to the interests of a user and provide the personalized feed of content to a user of the digital magazine server 140.

### Digital Magazine Server

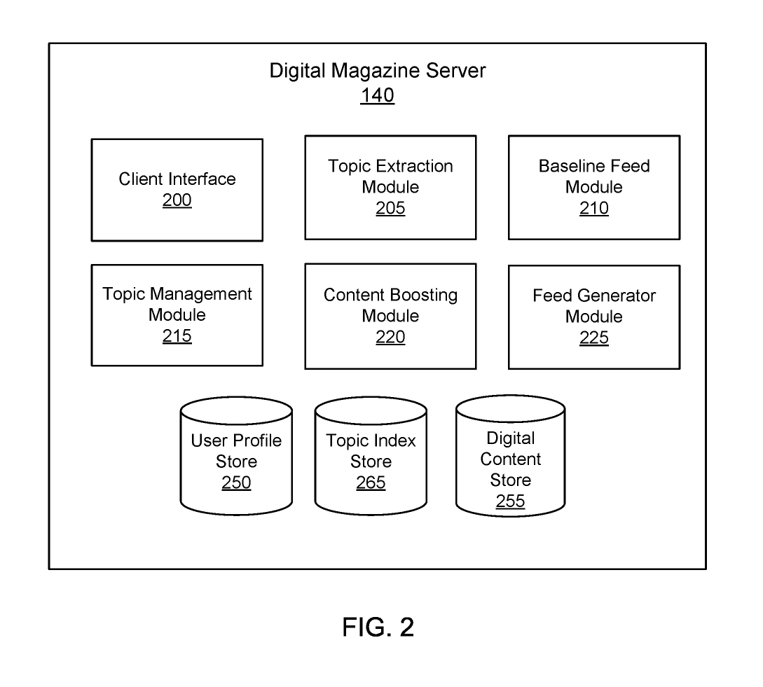

FIG. 2 illustrates a block diagram of a digital magazine server 140, in accordance with an embodiment. The digital magazine server 140 includes a client interface 200, a topic extraction module 205, a baseline feed module 210, a topic management module 215, a content boosting module 220, and a feed generator module 225. In various embodiments, the digital magazine server 140 may include additional, fewer, or different components for various applications. Conventional components such as network interfaces, security functions, load balancers, failover servers, management and network operations consoles, and the like are not shown so as to not obscure the details of the system architecture.

In various embodiments, a digital magazine server 140 may store user information to better understand the content that is to be provided to a user of the digital magazine server 140. For example, a user of the digital magazine server 140 can be associated with a user profile stored in a user profile store 250 maintained by the digital magazine server 140. A user profile includes declarative information about the user that was explicitly shared by the user and may also include profile information inferred by the digital magazine server 140. In one embodiment, a user profile includes multiple data fields, each describing one or more attributes of the corresponding user of the digital magazine server 140. Examples of information stored in a user profile include biographic, demographic, and other types of descriptive information, such as work experience, educational history, gender, hobbies or preferences, and geographic location, if explicitly shared by the user. A user profile may also include a list of topics and a list of sources of content that the user has curated over time. The list of topics associated with a user includes information describing which topics the user has indicated interest based on user's interactions with content items and comments on the content items presented to the user. This list of topics and the list of sources of content can be used to determine what content items to include in a personalized feed of content. The user profile may include a username and a user icon or avatar that identifies the user of the digital magazine server 140. A user profile may also include information about the user's interactions with other users of the digital magazine server 140, such as the user's influencers and known bloggers who contribute to the sites that are included in the user's list of sources of content the user has curated over time, and with content items of the digital magazine presented to the user.

The client interface 200 generally manages communications between the digital magazine server 140 and the client device 130. More specifically, the client interface 200 provides information to and receives information from the client device 130 such that a personalized feed of content can be presented to a user of the client device 130. As an example, the client interface 200 receives instructions and/or requests from the client device 130 for a personalized feed of content. The client interface 200 provides the personalized feed of content generated by the digital magazine server 140 to the client device 130, such that a user of the client device 130 can access content items that are likely of high interest to the user. In various embodiments, instead of providing a generated feed, the client interface 200 provides the content items and instructions (e.g., executable computer code for executing a digital magazine application on the client device 130) such that the client device 130 can generate a personalized feed in a digital magazine for presentation to the user according to the provided content items and instructions.

As another example, information includes particular topics and/or subtopics of interest selected by the user of the client device 130. The client interface 200 may retrieve and provide a general list of topics and/or subtopics stored in the topic index store 265 to the client device 130. In response, the client interface 200 receives selections of one or more topics or subtopics from the client device 130 that the user is interested in. The client interface provides the information identifying user interest in topics or subtopics to the topic management module 215 for further analysis in generating the personalized feed of content.

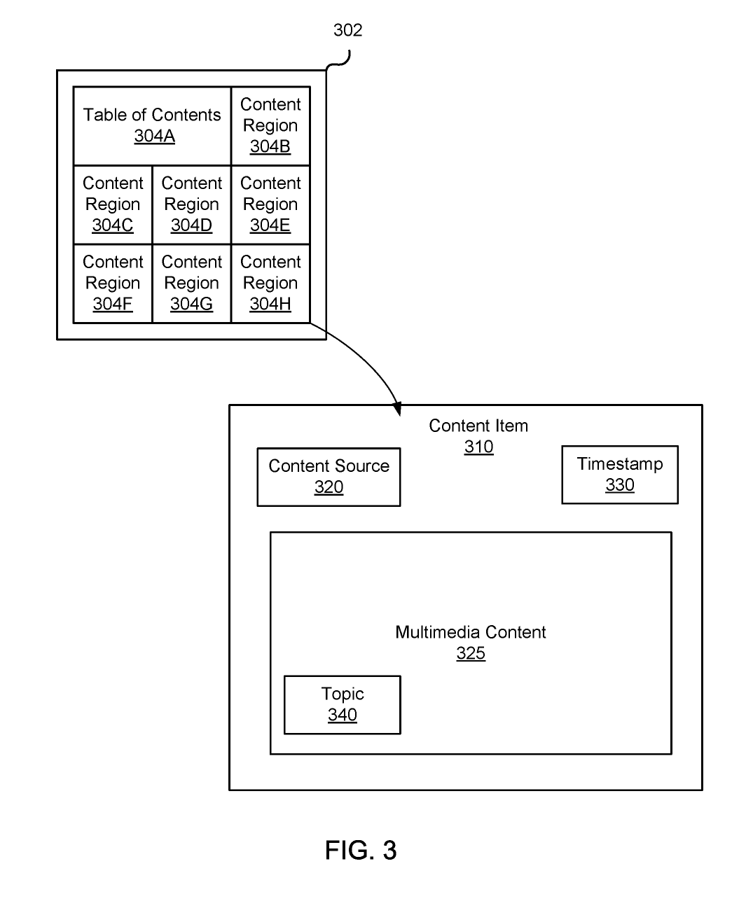

Reference is now made to FIG. 3, which depicts an example personalized feed of content in a digital magazine to a user of the digital magazine server 140, in accordance with an embodiment. In various embodiments, the digital magazine utilizes a page template 302 with multiple content regions 304 for presenting one or more content items received from a source 110. Other page templates with different configurations of slots (e.g., slot locations, slot size, and the like) may be used by the digital magazine server 140 to present one or more content items received from sources 110. In various embodiments, the slots within a page template may be arranged hierarchically such that content items in a personalized feed of content can be arranged based on the hierarchy. For example, a page template is organized hierarchically, where an arrangement of slots may be specified for the entire page template or for one or more portions of the page template. Content items may be ranked and therefore, placed in the hierarchical page template 302 based on their rankings. In other embodiments, the personalized feed of content of a digital magazine may be sequentially presented content items 310 that a user can scroll or “flip” through. For example, the most relevant (e.g., highest ranked) content item for a user of the digital magazine server 140 may be presented as a first content item subsequently followed by lower ranked content items.

Each content region 304 can present information retrieved from a corresponding content item 310. Examples of content items included in a digital magazine include, but is not limited to, a page post, a status update, a photograph, a video, a link, an article, video data, audio data, a check-in event at a location, or any other type of content. Each content item 310 may include multimedia content 325, text data, or any combination of multimedia and text data. For example, as depicted in FIG. 3, a content item 310 includes an identification of a content source 320 as well as a timestamp 330 that corresponds to when the content item 310 was made available by the content source. Additionally, the content item 310 can include multimedia content 325 (e.g., an image or video) and one or more topics 340 that the content item is associated with. A topic 340 is assigned to a content item by the digital magazine server 140 and is described in further detail below. In various embodiments, each content item 310 displayed in a content region 304 may include more or less information than the embodiment displayed in FIG. 3.

Returning to FIG. 2, the topic extraction module 205 receives content items 310 from various sources 110 and extracts relevant topics from each content item 310. More specifically, upon receiving each content item, the topic extraction module 205 analyzes the content item in order to associate the content item with topics and subtopics of the topic index store 265. In one embodiment, topics are represented by key terms and/or phrases associated with a content item. A subtopic is related to the topic and provides information describing one aspect of the topic. A topic and/or subtopic may be a tag that is assigned to a content item. For example, a topic may be “sports” and a subtopic may be “basketball.” In some embodiments, topics and/or subtopics are included by a source 110 in the metadata of a content item (e.g., hashtags). In some embodiments, the topic extraction module 205 identifies a related topic and/or subtopic through a content element of the content item. For example, if a content element were the text included in the content item, the topic extraction module 205 may identify a topic or subtopic based on the appearance or frequency of appearance of a word or phrase in the content item. As another example, if the content element were a multimedia image/video, the topic extraction module 205 may employ image recognition algorithms to identify a topic or subtopic of the content item. Additionally, topics or subtopics may be determined based on video captions, categories, titles, photo titles, or photo captions. In another embodiment, topics or subtopics for a content item may be identified by a model trained by a supervised learning algorithm that automatically extracts the topic and/or subtopic from the content within the content item. In another embodiment, topics and/or subtopics may be manually assigned to a content item.

In another embodiment, the topic extraction module 205 identifies a topic of a content item by parsing the text of the content item based on the words in the text of the content item and the semantic relations between the words. For example, the topic extraction module 205 parses the text into semantic tokens. A semantic token can be a word, phrase, or other combinations of words. The topic extraction module 205 determines the syntactic relationships between the semantic tokens representing each sentence of the text of the content item. As an example, the sentence “Berkeley argued for immaterialism” may be parsed into a tuple containing semantic tokens corresponding to the noun “Berkeley”, the verb “to argue”, the preposition “for”, and the noun “Immaterialism.” The topic extraction module 205 identifies the noun “Berkeley” as the topic of the content item and identifies the preposition “for” and the noun “Immaterialism” as a prepositional phrase that acts as an adverbial clause.

Based on the analysis, the topic extraction module 205 may further associate a weight that indicates a strength of association between the content item and a topic/subtopic or an estimated likelihood that the content item is related to the topic/subtopic. In one embodiment, the topic extraction module 205 determines the weight of a content item with respect to a selected topic based on a topic relevance score for the content item. The topic relevance score for a content item with respect to a selected topic is determined based on a measure of similarity between a vector of semantic tokens of the content item and a vector of semantic tokens of the selected topic. Example measures of similarity include cosine similarity or the generalized Euclidean distance between the vector associated with the content item and the vector associated with the selected topic. Responsive to the topic relevance score associated with the content item exceeding a threshold value, the topic extraction module 205 selects the content item for the selected topic. Given the identified topics, subtopics, and associated weights with each, the topic extraction module 205 generates a vector for the content item. In various embodiments, the vector includes each of the identified topics, subtopics, as well as each associated weight.

The baseline feed module 210 receives content items that are associated with topics and/or subtopics from the topic extraction module 205. The baseline feed module 210 generates and maintains baseline content feeds that includes the content items. In various embodiments, each baseline feed of content is specific for a topic designated by the digital magazine server 140. As previously stated, topics and subtopics may be stored in the topic index store 265. In one embodiment, the topic index store 265 may store a topic hierarchy that includes a topic and multiple levels of subtopics below the topic. For example, a topic may be “Sports” followed by a first subtopic of “NBA,” followed by a further subtopic of “Golden State Warriors,” followed by a further subtopic of “Stephen Curry.”

Therefore, the baseline feed module 210 receives content items from the topic extraction module 205, determines that the content item is related to one or more topics, and categorizes the content item into baseline feeds of content that are specific for each of the one or more topics.

In various embodiments, the baseline feed module 210 categorizes the content items into various baseline feeds of content based on their respective descriptive vectors that include the identified topics and associated weights. For example, the content items are categorized using one or more standard clustering techniques (e.g., K-means, expectation-maximization, density-based clustering techniques). Hence, content items relating to a topic are grouped into a baseline feed of content that is specific for that topic. Generating vectors associated with content items and clustering content items based on the vectors is further described in U.S. patent application Ser. No. 14/164,089, filed on Jan. 24, 2014, which is hereby incorporated by reference in its entirety.

In various embodiments, the baseline feed module 210 further scores and ranks the content items included in a baseline feed of content that is specific for a topic. The baseline feed module 210 may consider various factors in scoring and ranking the content items such as an indication as to the quality of each content item as well as the weight indicating the degree in which the content item is related to the topic. Scoring of a content item in a digital magazine server 140 is described in further detail in U.S. patent application Ser. No. 14/089,564, filed on Nov. 25, 2013, which is hereby incorporated by reference in its entirety.

The baseline feed module 210 stores the URLs of the content items that are included in a baseline feed as well as associated information in the digital content store 255. Each content item included in the baseline feed is based on the content of a resource on the Internet to which a corresponding URL references to. For example, associated information may include ranking information of the content item in the baseline feed of content. As another example, associated information includes an identification of the related topic (e.g., a topic stored in the topic index store 265). Therefore, when the baseline feed of content for a specific topic is required at a subsequent time, the content items corresponding to the topic can be readily retrieved. In some scenarios, the URLs of the content items and/or the content items themselves are only stored in the digital content store 255 for a threshold amount of time to enable new content items to be included in a baseline feed of content.

### Boosting Content Items in a Baseline Feed Related to a Topic

The topic management module 215 identifies content items in the baseline feed that are to be boosted based on a user's interests. In one embodiment, the topic management module 215 identifies content items in a baseline feed to be boosted based on user selection of subtopics, signals of user's social behavior and/or the combination of thereof. For example, the topic management module 215 identifies topics that the user is interested in and further identifies subtopics related to each topic of interest. Amongst the subtopics, the topic management module 215 infers subtopics that the user may be interested in. Therefore, the topic management module 215 retrieves a baseline feed of content that is specific for a topic that the user interested in, and subsequently, identifies content items in the baseline feed of content that are associated with a subtopic that the user may be interested in. As another example, the topic management module 215 identifies content items to be boosted if the content items are from the user's influencers or from other users who have a close social relationship with the user.

More specifically, the topic management module 215 first receives a selection of topics that a user has indicated interest in from the client interface 200. As an example, the digital magazine server 140 may present the user with numerous topic choices and as a result, the digital magazine server 140 receives the selected topics of interest from the user. In one embodiment, the digital magazine server 140 presents topics to and receives selected topics from a user when the user is interacting with the digital magazine server 140 for the first time.

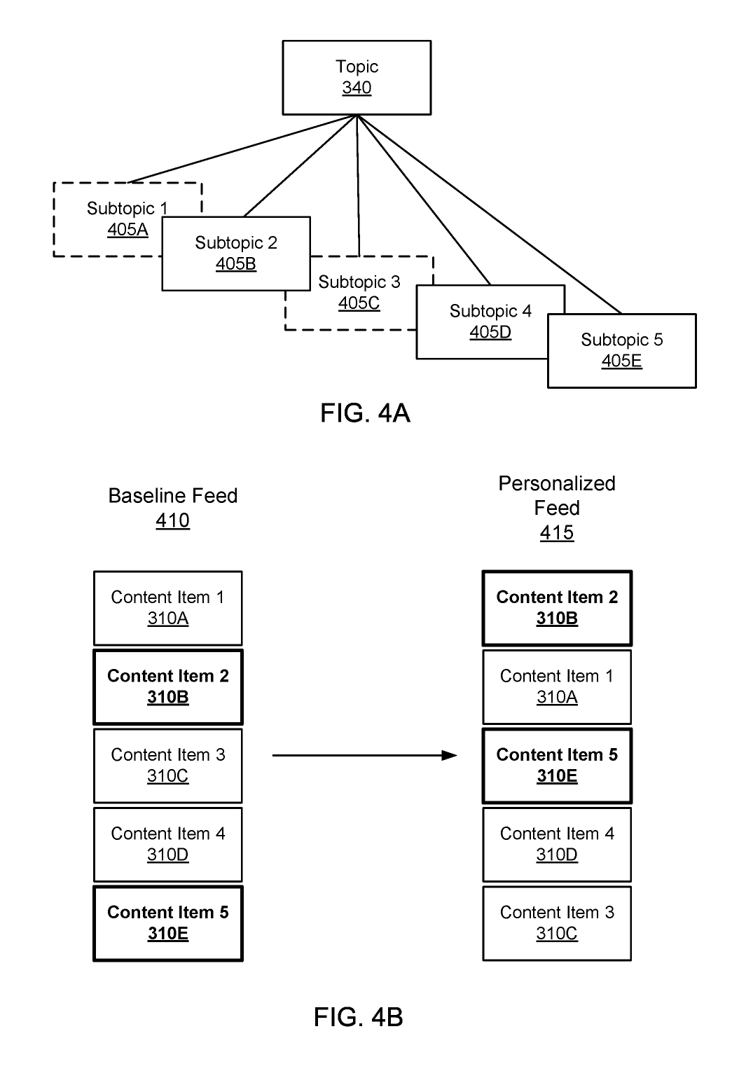

In various embodiments, each selected topic was previously stored by the digital magazine server 140 in the topic index store 265 and may be associated with one or more subtopics. For example, FIG. 4A illustrates multiple subtopics 405 associated with a topic 340 in a digital magazine server 140, in accordance with an embodiment. In various embodiments, subtopics 405 are more specific than a topic 340 and therefore, provide an additional level of granularity in understanding a user's interests. As a specific example, a topic 340 of the digital magazine server 140 may be “cute animals” which are related to “wildlife” (e.g., subtopic 1 (405A)), “dogs” (e.g., subtopic 2 (405B)), “veterinary medicine” (e.g., subtopic 3 (405C)), and “pets” (e.g., subtopic 4 (405D)).

In various embodiments, a subtopic 405 of a topic 340 may be an entity (e.g., a magazine, a publisher) such as a source 110 that provides content items related to the topic 340. Additionally, a subtopic 405 may be a person such as an individual that provides content items related to the topic 340 or an individual that is often affiliated with a topic 340. For example, if the topic 340 is “fashion,” then a famous celebrity that is often deemed fashionable may be associated as a subtopic 405. For another example, the subtopic is the user's influencers or other users who have a close social relationship with the user. Using FIG. 4A as an example, the topic 340 has a subtopic (e.g., subtopic 5 (405E)), which is a source 110 that commonly publishes cute animal content items.

Given a topic 340 that the user has indicated interested in, the topic management module 215 further identifies subtopics 405 that the user may be specifically interested in. In one embodiment, the topic management module 215 may provide a list of the identified subtopics 405 to the client device 130 such that a user of the digital magazine server 140 can provide a user selection of subtopics 405 that the user is interested in. As such, the topic management module 215 directly receives an indication as to the subtopics 405 of interest for the user of the magazine server 140.

In another embodiment, the topic management module 215 infers whether the user is interested in a subtopic 405 given prior actions that the user has performed on the digital magazine server 140. As an example, the topic management module 215 may retrieve a user profile corresponding to the user of the digital magazine server 140 from the user profile store 250 and analyze the available information in the user profile, such as a list of user's influencers and a list of URLs of resources the user has curated over time. A user profile may include various prior actions that the user has previously performed on the digital magazine server 140. Example actions by the user include: accessing a content item, viewing a content item, sharing a content item with another user of the digital magazine server 140, saving a content item to the client device 130, liking/disliking a content item, sharing a content item, providing a comment associated with a content item, providing a content item to the digital magazine server 140, or following a source 110 that provided a content item.

Returning to the prior example involving the topic 340 of “cute animals,” the topic management module 215 may obtain a user profile for a user that indicates an affinity towards “dogs” (e.g., subtopic 2 (405B)) and “pets” (e.g., subtopic 4 (405D)). For example, the user may have previously provided positive feedback towards a content item involving a dog and may have shared another content item related to pets. As such, the topic management module 215 identifies subtopic 2 (405B) and subtopic 4 (405D) as subtopics of interest for the user. Additionally, the user may have previously followed a provider of content (e.g., subtopic 5 (405E)) that often provides cute animal content items. Therefore, the topic management module also identifies subtopic 5 (405E) as a subtopic of interest. The topic management module 215 may not identify any relevant information relevant to subtopic 1 (405A) and subtopic 3 (405C) and therefore, does not deem those subtopics as of interest for the user (e.g., as indicated by their dotted lines).

In various embodiments, the topic management module 215 further associates a weight with each subtopic 405 that indicates the measure of affinity between the user of the digital magazine server 140 and that subtopic 405. For example, for subtopic 1 (405A) and subtopic 3 (405C), a default weight may be assigned that indicates a lack of affinity from the user to those subtopics. Alternatively, subtopics 2, 4, and 5 may each be assigned a higher weight to reflect the user interest. The weight assigned by the topic management module 215 may scale according to the number of prior user actions performed by the user that are relevant to the subtopic. In another embodiment, the subtopic may be a provider of content (e.g., newspaper, magazine, or individual) that the user has followed and the weight assigned by the topic management module 215 may scale according to a duration of time that the user has been following the provider of content. In various embodiments, if the user interest in a subtopic is provided directly by the user, the topic management module 215 may assign a higher weight as opposed to if the user interest in a subtopic is inferred.

Reference will now be made to FIG. 4B, which depicts the boosting of content items within a baseline feed 410, in accordance with an embodiment. For a topic 340 that the user has expressed interest in, the topic management module 215 retrieves a baseline feed of content including content items that are related to the selected topic 340. As previously described, the baseline feed of content contains content items received from a source 110, some of which are to be boosted to better match the user's personal interest and preference for content items.

The topic management module 215 identifies content items that are to be boosted in the baseline feed 410 based on the subtopics that the user is likely interested in. As previously described, each content item 310 in the baseline feed 410 is related to the topic 340 but may additionally be related with one or more subtopics 405. Therefore, the topic management module 215 identifies the content items 310 in the baseline feed 410 that are also affiliated with the identified subtopics 405 of interest such as subtopic 2 (405B), subtopic 4 (405D), and subtopic 5 (405E). As depicted in FIG. 4B, the topic management module 215 identifies content item 2 (310B) and content item 5 (310E) as being the content items 310 in the baseline feed that are related to one or more subtopics of interest. As an example, content item 2 (310B) may be provided by a provider of content that is subtopic 5 (405E). Therefore, the fact that the content item 2 (310B) is provided by the identified subtopic 5 (405E) that is of interest to the user causes the content item 2 (310B) to be identified. The topic management module 215 provides the identified content items to the content boosting module 220 in order to personalize the baseline feed 410.

The content boosting module 220 ranks the content items 310 from the baseline feed 410 while accounting for the user's interest in various subtopics 405. Specifically, the content boosting module 220 retrieves the baseline feed 410 of content and also receives the identified content items of the baseline feed 410 from the topic management module 215. As such, the content boosting module 220 boosts the identified content items (e.g., content item 2 and 5) relative to the other content items in the baseline feed 410 that are not related to one or more subtopics of interest. Referring to the personalized feed 415 depicted in FIG. 4B, the content items 310 in the personalized feed 415 have been rearranged as content item 2 (310B) has been boosted to a higher position as compared to content item 1 (310A) and content item 5 (310E) has been boosted to a higher position as compared to content items 3 (310C) and 4 (310D).

In various embodiments, the content boosting module 220 boosts the scores associated with each identified content item (e.g., content item 2 and content item 5) and the ranking of the content items 310 are conducted according to their associated scores. For example, the content items 310 in a baseline feed 410 may have been initially scored and ranked. In the embodiment shown in FIG. 4B, the content boosting module 220 boosts the scores associated with content item 2 (310B) such that the score associated with content item 2 (310B) is higher than the score associated with content item 1 (310A). Likewise, the score associated with content item 5 (310E) is boosted such that it is higher than either score of content item 3 (310C) and content item 4 (310D). In other embodiments, boosting a score of a content item 310 in the baseline feed 410 may not result in a change in the ranking of the content item 310 in the personalized feed 415.

The extent to which a content item 310 is boosted may depend on a variety of factors. For example, the content boosting module 220 may consider the weight that indicates a measure of affinity between the user and a subtopic 405 as well as the weight corresponding to a degree in which the content item 310 is related to the subtopic 405. An increase in either weight, which indicates a higher correlation between a user and the subtopic 405 or between the content item 310 and the subtopic, would result in a larger extent of boosting for the content item 310. Alternatively, a decrease in either weight would result in a smaller extent of boosting for the content item 310.

The content boosting module 220 generates an updated ranking of the content items 310, now updated to account for user interest in subtopics 405, and provides them to the feed generator module 225 for generation of the personalized feed 415. In various embodiments, the content items 310 are ranked according to their respective scores, some of which may have been boosted relative to their scores in the baseline feed 410.

The feed generator module 225 receives the rankings of content items from the content boosting module 220 and generates a personalized feed of content for a user of the digital magazine server 140 according to the received content rankings. In various embodiments, the feed generator module 225 may receive more than one content ranking from the content boosting module 220. For example, if a user originally indicated multiple topics 340 of interest, the feed generator module 225 may receive a content ranking for each topic 340, each content ranking specifying the ranking of content items 310 that are related to that topic 340. The feed generator module 225 may impose rules specifying how content items are to be included in the consolidated personalized feed. In various embodiments, at least one content item from each topic 340 is selected for inclusion into the consolidated personalized feed in order to diversify the feed according to the user's interests. For example, the highest ranked content item 310 from each content ranking is selected for inclusion. Therefore, the feed generator module 225 may generate a personalized feed 415 that represents a consolidated feed with content items 310 from various topics 340 that the user has indicated interest in. Inclusion of content items into a consolidated feed based on their associated scores is described in further detail in U.S. application Ser. No. 14/567,840, filed on Dec. 12, 2014, which is hereby incorporated by reference in its entirety.

In various embodiments, the personalized feed is designed such that the first content item presented to a user is the most relevant for the user given the previous analysis. For example, this may be a highest ranking content item in a content ranking provided by the content boosting module 220. Subsequent content items presented to the user may be lower ranked content items or another content item from a different content ranking.

In various embodiments, the feed generator module 225 retrieves a template (e.g., the template 302 shown in FIG. 3) of a digital magazine for generating a personalized feed. Given the types of content items in the content rankings, the feed generator module 225 may select a page template 302 from various candidate page templates based on characteristics of the slots in different candidate page templates and based on characteristics of the content items. For example, if there are a certain number of content items with an informative image, the feed generator module 225 can select page templates that include a threshold number of content regions 304 to place the content items with images. The feed generator module 225 selects a page template to generate the personalized feed of content.

In the example of FIG. 3, when a digital magazine server 140 generates a page for presentation to a user, the feed generator module 225 populates slots in a page template 302 with content items 310. Each content region 304 in the template 302 may be located on the template 302 according to a hierarchical ranking, and content items 310 may be placed into a corresponding content region 304 according to the ranking. For example, the highest ranking content item listed in a content rankings provided by the content boosting module 220 may be placed into a first content region 304B that is most prominently (e.g., at the top) featured in the template 302. Therefore, a user of the digital magazine server 140 that is presented with the personalized feed can access the highest ranked content item with ease. In other embodiments, a prominent content region 304 located in a template 302 may be the largest content region or the content region located at the center of the digital magazine.

Once the personalized feed of content is generated, the feed generator module 225 provides the personalized feed 415 to the client interface 200 which is then communicated to the client device 130. In another embodiment, the feed generator module 225 may provide the content items of a personalized feed 415 as well as instructions as to how the content items are to be presented relative to one another, such that the client device 130 can assemble the personalized feed 415 and present it accordingly to a user of the digital magazine server 140.

### Process of Generating a Personalized Feed of Content

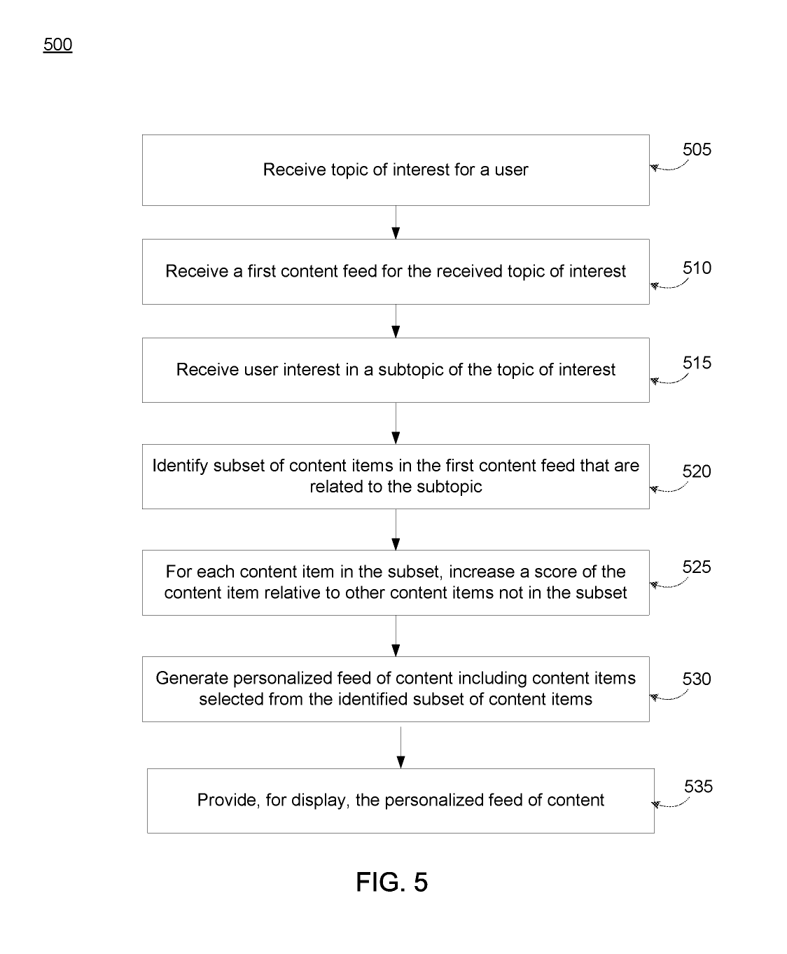

FIG. 5 is a flowchart 500 for generating a personalized feed of content for a user of the digital magazine server 140, in accordance with an embodiment. The digital magazine server 140 receives 505 a topic of interest for a user. As an example, the digital magazine server 140 may receive the topic as a user-provided selection. The digital magazine server 140 receives 510 a baseline feed of content that is specific for the received topic of interest. In various embodiments, the baseline feed was previously generated by the digital magazine server 140 and includes content items that are related to the topic of interest.

A topic may be associated with various subtopics in the digital magazine server 140. Therefore, the digital magazine server 140 identifies 515 user's interest in at least one subtopic related to the received topic of interest. For example, user interest may be a prior user action taken by the user of the digital magazine server 140. The digital magazine server 140 further identifies 520 content items included in the baseline feed of content 410 that are also related to the subtopic that the user has expressed interest in. For each of the identified content items related to the subtopic, the digital magazine server 140 boosts the identified content item relative to other content items in the baseline feed of content 410 that are not related to the subtopic. For example, the score of each identified content item related to the subtopic is boosted whereas the score of each content item unrelated to the subtopic is held. In doing so, the digital magazine server 140 personalizes the baseline feed of content 410 for a specific user based on the user's interests.

The digital magazine server 140 generates 530 the personalized feed of content 415 including the boosted content items that are placed at a particular location within the personalized feed based on the extent that each content item is boosted. The digital magazine server 140 provides 535 the personalized feed 415 to a client device 130 for display to a user of the digital magazine server 140.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for presenting content in a digital magazine to a user of a digital magazine server, the method comprising:
receiving a first content feed for a topic that the user is interested in, the first content feed having a plurality of content items associated with the topic;
receiving user interest in a subtopic of the topic of interest, the subtopic providing an additional level of granularity in understanding the user's interest in the topic;
identifying a subset of content items from the first content feed, each content item in the identified subset being related to the subtopic;
for each content item in the identified subset, increasing a score of the content item relative to other content items not in the identified subset, the score of the content item indicating a level of interest of the user in the content item;
generating a personalized content feed for the topic, the personalized content feed including one or more content items selected from the identified subset of content items based on corresponding increased scores; and
providing, for display to the user of the digital magazine server, the personalized content feed.

2. The method of claim 1, wherein the subtopic is a provider of content items related to the topic and the user interest in the subtopic corresponds to a prior user action that followed the provider of content items.

3. The method of claim 1, wherein the subtopic is an individual and the user interest in the subtopic corresponds to a prior user action that followed the individual in the digital magazine server.

4. The method of claim 1, wherein each content item in the first content feed has an initial ranking corresponding to a degree of the user's interest in the content item

5. The method of claim 1, wherein each content item in the identified subset is characterized by a strength of association that corresponds to a degree in which the content item is related to the subtopic.

6. The method of claim 1, wherein user interest in the subtopic is inferred based on social signals describing user actions performed by the user on content items presented to the user.

7. The method of claim 1, wherein user interest in the subtopic is inferred based on social signals describing sources of content that the user has curated over time.

8. The method of claim 1, wherein the user interest in the subtopic is determined based on a measure of affinity between the user and the subtopic, wherein the determined measure of affinity is higher if the user interest is provided by the user as compared to if the user interest is inferred.

9. The method of claim 1, wherein user interest in the subtopic is determined to be high if a content item on the subtopic is provided by an individual who has been followed by the user over a period of time.

10. The method of claim 1, wherein increasing a score of the content item is based on a strength of association between the content item and the subtopic and a measure of affinity between the user and the subtopic.

11. A non-transitory computer-readable medium comprising computer program instructions, the computer program instructions when executed by a processor of a computer device causes the processor to perform the steps including:
receiving a first content feed for a topic that the user is interested in, the first content feed having a plurality of content items associated with the topic;
receiving user interest in a subtopic of the topic of interest, the subtopic providing an additional level of granularity in understanding the user's interest in the topic;
identifying a subset of content items from the first content feed, each content item in the identified subset being related to the subtopic;
for each content item in the identified subset, increasing a score of the content item relative to other content items not in the identified subset, the score of the content item indicating a level of interest of the user in the content item;
generating a personalized content feed for the topic, the personalized content feed including one or more content items selected from the identified subset of content items based on corresponding increased scores; and
providing, for display to the user of the digital magazine server, the personalized content feed.

12. The non-transitory computer-readable medium of claim 11, wherein the subtopic is a provider of content items related to the topic and the user interest in the subtopic corresponds to a prior user action that followed the provider of content items.

13. The non-transitory computer-readable medium of claim 11, wherein the subtopic is an individual and the user interest in the subtopic corresponds to a prior user action that followed the individual in the digital magazine server.

14. The non-transitory computer-readable medium of claim 11, wherein each content item in the first content feed has an initial ranking corresponding to a degree of the user's interest in the content item

15. The non-transitory computer-readable medium of claim 11, wherein each content item in the identified subset is characterized by a strength of association that corresponds to a degree in which the content item is related to the subtopic.

16. The non-transitory computer-readable medium of claim 11, wherein user interest in the subtopic is inferred based on social signals describing user actions performed by the user on content items presented to the user.

17. The non-transitory computer-readable medium of claim 11, wherein user interest in the subtopic is inferred based on social signals describing sources of content that the user has curated over time.

18. The non-transitory computer-readable medium of claim 11, wherein the user interest in the subtopic is determined based on a measure of affinity between the user and the subtopic, wherein the determined measure of affinity is higher if the user interest is provided by the user as compared to if the user interest is inferred.

19. The non-transitory computer-readable medium of claim 11, wherein user interest in the subtopic is determined to be high if a content item on the subtopic is provided by an individual who has been followed by the user over a period of time.

20. The non-transitory computer-readable medium of claim 11, wherein increasing a score of the content item is based on a strength of association between the content item and the subtopic and a measure of affinity between the user and the subtopic.

21. A method for presenting content in a digital magazine to a user of a digital magazine server, the method comprising:
receiving a plurality of topics that are of interest for the user;
for each topic of interest:
receiving a first content feed for the topic of interest;
identifying user interest in a subtopic of the topic of interest, the subtopic providing an additional level of granularity in understanding the user's interest in the topic;
identifying a subset of content items from the first content feed, each content item in the identified subset being related to the subtopic;
for each content item in the identified subset, increasing a score of the content item relative to other content items not in the identified subset, the score of the content item indicating a level of interest of the user in the content item;
generating a consolidated personalized content feed including at least one content item in the identified subset of content items from each topic of interest, each content item located in the consolidated personalized content feed based on their associated score;
providing, for display to the user of the digital magazine server, the consolidated personalized content feed.

22. The method of claim 21, wherein a subtopic of one of the plurality of received topics of interest is a provider of content items related to the one of the plurality of received topics of interest and the user interest in the subtopic corresponds to a prior user action that followed the provider of content items.

23. The method of claim 21, wherein the subtopic of one of the plurality of received topics of interest is an individual and the user interest in the subtopic corresponds to a prior user action that followed the individual in the digital magazine server.
